(19) United States
(12) Patent Application Publication
(10) Pub. No.: US 2017/0212257 A1
(43) Pub. Date: Jul. 27, 2017

(54) BROADBAND GEOPHONE ACCELEROMETER

(71) Applicant: Chunhua Gao, Windsor (CA)

(72) Inventor: Chunhua Gao, Windsor (CA)

(21) Appl. No.: 15/007,134

(22) Filed: Jan. 26, 2016

(51) Int. Cl. G01V 1/18

(52) U.S. Cl. CPC G01V 1/182

(57) ABSTRACT

A closed loop broadband geophone which is made by using a high performance method to measure a mechanical vibration is disclosed. All coil portions of the two or more coil sets are located in at least 4 separate recesses of the bobbin. Each coil portion of these coil sets has an individual magnetic field magnitude using Faraday's Law and Lorentz's Law. This mathematic method, significantly improves the accuracy of both measuring the mechanical vibration and providing feedback control to the sensor coils. These coil sets are connected to an electronic device which processes the measuring signal and a feedback signal to the sensing coil as a precision digital forcing signal for a reference position.

This application claims the benefit of U.S. Provisional Application Ser. No. 62/110,542, filed on Feb. 1, 2015.

### FIELD OF THE DISCLOSURE

The present disclosure generally relates to a seismic data acquisition apparatus, and in particular, a multiple-coil, multiple-terminal geophone accelerometer.

### BACKGROUND

1. Field of the Invention

This invention relates generally to the field accelerometers, and in particular to methods and closed loop accelerometers, and more specifically to an accelerometer used in a seismic data acquisition system, micro seismic monitoring/acquisition system.

2. Description of the Prior Art

It is well known that the current conventional geophones are still widely used in seismic exploration to acquire/measure the vibration signal from the ground, primarily due to low cost, lack of reliance on power and high reliability. However, current conventional geophones are still unsatisfactory due to their narrow frequency bandwidth, and high total harmonic distortion (THD). As seismic acquisition systems have rapidly been developed to service high-resolution seismic exploration, higher performance geophones are needed to match such exploration requirements. In recent years, the micro-electromechanical systems (MEMS) digital sensors, in which more improvements have been developed, have been used in many seismic exploration projects. These closed-loop MEMS sensors have 3 to 375 Hz bandwidth and lower THD of approximately 0.001% dB. However, these sensors are still not widely used, as they are both expensive and fragile. Therefore, a geophone with lower cost, broadband frequency and small THD is highly desired by the exploration market. From U.S. Pat. No. 5,172,345, Jacobus W. P. van der Poel disclosed a geophone system for measuring mechanical vibrations. This geophone system has a sensing coil, a driving coil and a compensation coil wound into 3 recesses of its bobbin separated. The sensing coil is wound in top recess of its bobbin and the compensation coil is wound in the bottom recess of its bobbin. The sensing coil is in series with the compensation coil. The sensing coil and compensation coil of the first coil set is connected with the input of the electronic processing device. The driving coil of the second coil set is wound in the middle recess of its bobbin and also connected with the electronic processing device. Both of the two coil sets are connected to two outside electronic processing devices separated. To manage the moving coil of the first coil set, the electronic processing device has been used as a feedback control module by sending a current to the driving coil of the second coil set. The magnet field magnitude of each of these three coil sets are not even and this can make big differences when using Faraday's Law and Lorentz's law. This is not easy to make in real world. In US20140293752A1, Zhentang Fu, Chunhua Gao and Du Chen disclosed a multi-coil multi-terminal closed-loop geophone accelerometer. Comparing with Jacobus's method, Zhentang Fu et. al. use only 2 recesses and put the middle driving coil overlapped with sensing coils. This makes the geophone easier to be practiced in real world and will have better performances than before. However, the magnet field magnitude of each of their coil sets are not even and this can still make big differences when using Faraday's Law and Lorentz's law. In U.S. Pat. No. 8,139,439, Masahiro Kamata presented a seismic sensor calibration method by injecting a current into a moving coil of a seismic sensor and measuring the voltage across the moving coil. In U.S. Pat. No. 6,101,864, Michael L. Abrams et. al disclosed a high performance method and apparatus for testing a closed loop transducer. By using ΣΔ and analog-to-digital converter (ADC) technologies, a closed loop feedback circuit is attached to a sensor. This invention includes a method and apparatus for combining with the one-bit ΣΔ modulated feedback signal a special purpose one-bit modulated test signal which acts as a precision forcing signal on the mass of the sensor. When such test bitstream is inserted into the feedback circuit, the transducer forward circuit senses the test signal as an external force applied to the transducer, which must be zeroed by the transducer feedback loop. Recording of the sensor ADC output provides a signal which may be compared with the test signal for evaluation of the transducer. From U.S. Pat. No. 5,469,408, Daniel M. Woo presented a high resolution geophone. The amount of harmonic distortion is reduced by making pole pieces longer than coil frame length to provide a uniform magnetic field in which the two coil portions of single coil set move.

Larger energy reserves across the globe have been discovered. The oil and gas industry now focuses on narrow, deeper energy reserve places. Therefore, new technologies are required to match such requirements. This underlies the need for high density and high-resolution seismic acquisition technologies. Broadband geophones, such as those down to 1 or 2 Hz frequency, available at lower cost and higher reliability are needed to support the exploration industry in discovering. This step change in geophone technology is required and will be welcomed by the oil and gas exploration industry.

### SUMMARY OF THE DISCLOSURE

The principles of this disclosure are directed to the technologies for highly improving the performances of current moving coil geophones, such as wider bandwidth (from 0.1 to 500 Hz) and lower THD (can be less than 0.001%). The current moving coil geophones measure the mechanical vibration based on Faraday's Law and it is expressed as follows:

\vec{E}=\vec{B}*L*\vec{V} (1)

Where, the \vec{E} represents the voltage across the moving coil, \vec{B} is the magnet field magnitude, \vec{V} is the velocity of moving coil and the L is the length of the coil wire. Measuring the voltage of the output signal, the mechanical vibration can be calculated by using the equation (1), because both \vec{B} and L are considering known parameters. Here \vec{B} is the magnet field magnitude in the space which the moving coil is moving around. However, lots of researchers (for example in U.S. Pat. No. 5,469,408) have already concluded that the magnet field magnitude \vec{B} of the space between the magnetic block and the inner wall of geophone sensor housing is not uniform. In this magnetic field, the magnet field magnitudes \vec{B} in some area are not equal to each other, because they might have different values or different direction. Only the magnet field magnitude of the area, where it is close to the shoulder face of the bobbin, could be considered as uniform. Therefore, in the coil's moving area, it is not accurate to put the magnet field magnitude \vec{B} as a constant by using equation (1). This could be the reason that the current moving coil geophone has higher THD. In the disclosure, coils are assembled separated in different recesses of the bobbin and the measuring coils are located in the most well distributed magnet field (or uniformed field). For example, the sensing coil is strictly assembled in the space of which they have the well distributed magnet field magnitude \vec{B}. The moving coil's height along the geophone housing's cylindrical axis is designed to match the height of magnetic boot shoulder face. And the sensing coil's moving path is controlled by driving coil (described below) and less than +/−0.0002 mm (the current most moving coil geophones have +/−2 mm). These will highly improve the performances of geophones.

As the moving coil geophone matches the conditions for closed-loop control, another coil set is added as a feedback controller. According to Lorentz's law, it is expressed as the follows:

\vec{F}=\vec{I}*L*\vec{B} (2)

By injecting a current \vec{I} to a coil, a force is generated using equation (2). The direction of the force is determined by the direction of the current. Therefore, a close loop system can be set up by putting one coil as measuring component and the other coil as the controller. For the purpose of minimizing the geophone dimensions and putting the measuring coil in the uniformed magnet field, both of the first coil set and the second coil set are wound to the bobbin separately. The first coil set (or the sensing coil) is wound to recesses which will have the most well distributed magnet field magnitude; the second coil set (or driving coil) is wound to recesses which will have the less well distributed magnet field magnitude. Therefore, the bobbin is designed to have four (4) recesses. The top recess and the bottom recess will be wound for sensing coil set and are assembled in the area of well-distributed magnet field magnitude. The middle two recesses are wound by two coils of the driving coil set. Located in separated recesses of the bobbin, each coil portion of these coil sets has an individual magnet field magnitude by using faraday's law (or equation (1)) and Lorentz's law (or equation (2)). By this mathematic method, the performances of the sensor are highly improved. Both the two coil sets are connected to an electronic device which processes the measuring signal and feedbacks the signal as a precision digital forcing signal to sensing coil as a reference position. The same methods also apply to magnetic block moving sensors which their coils and bobbin is stably assembled with housing.

### THE DRAWINGS

FIG. 1 is a cross section view of the geophone;

FIG. 2 illustrates the magnetic field formed by the magnetic structure of the geophone of FIG. 1;

FIG. 3 shows the magnetic block with magnetic boots on ends;

FIG. 4 illustrates the structure of the bobbin, coils, magnetic boot and magnetic block;

FIG. 5 is a cross section view of the bobbin within four (4) recesses;

FIG. 6 is a cross section view of a bobbin within six (6) recesses;

FIG. 7 is a simplified three-dimensional illustration of the windings of the sensing coil and driving coil sets of the movable coil structure of FIG. 1;

FIG. 8 is a simplified three-dimensional illustration of the separated windings of the three (3) coil sets;

FIG. 9 is a simplified three-dimensional illustration of the combined (united of separate and overlap) windings of the three (3) coil sets;

FIG. 10 is a circuit diagram of the digital geophone according to the invention;

### DETAILED DESCRIPTION

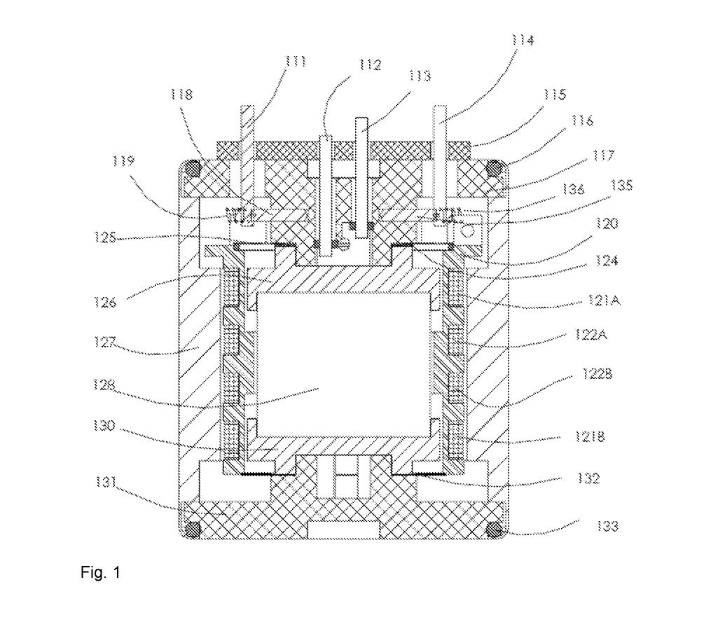

FIG. 1 shows the structure of the new geophone invention. Top convert board 115 is used for connection between inner coil sets and electronic processing device. While mounting to the top convert board 115, the 4 terminal pins (111,112,113,114) are connected to inner sensing coil 121 and driving coil 122. For protecting the pins, the electronic processing device is connected to the pins through the PCB convert board 115. Cap 117 is mounted to housing 127 with a top o-ring 116 for sealing. Pin 112 is connected to one end of sensing coil set by electric connection among top magnetic boot 126, magnetic block 128, bottom magnetic boot 130, and bottom spring 132 using the well-known technologies in this industry. Similarly, pin 113 is connected to another end of sensing coil set 121 by top spring 125. The top end of sensing coil set is soldered to top spring 125 which is isolated with top magnetic boot 126 using an insulation disc 124. The terminal 111 is connected to one end of driving coil set 122 via spring electrical wire 119 and pin 118 using the well-known technologies in this industry. By the same technologies, the terminal 114 is connected to another end of driving coil set 122 via spring electrical wire 136 and pin 135. From the invention, it shows that the bobbin 120 comprises 4 recesses around its cylindrical surface. The middle two recesses are for driving coil set, and both the top recess and bottom recess are for sensing coil set. The bobbin and two coil sets are axial moveable along the magnetic block 128 and supported by top spring 125 and bottom spring 132. The base 131 is assembled with bottom magnetic boot 130 and mounted to housing 127. Again, an o-ring 133 is assembled between the housing 127 and base 131 for sealing.

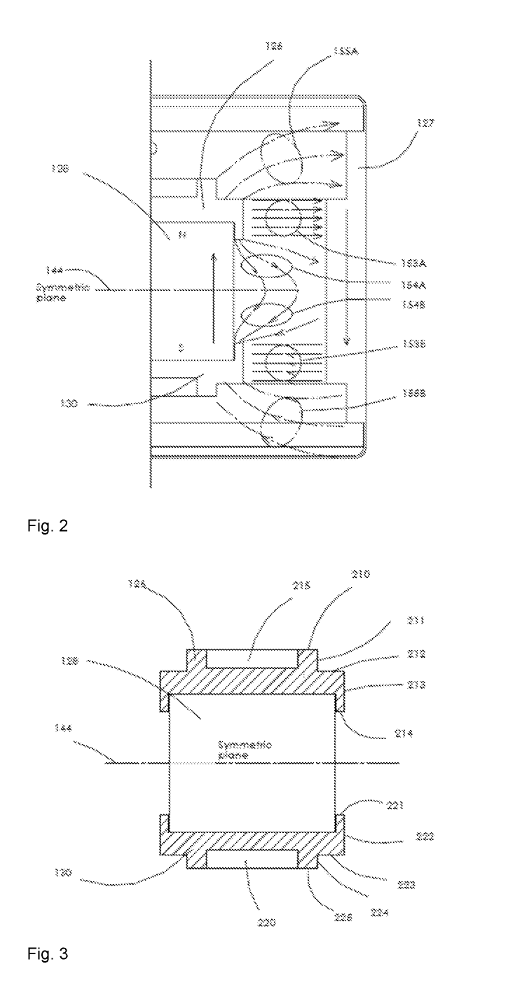

FIG. 2 shows the partial magnetic field formed by the magnetic structure of the invented geophone between the top magnetic boot, magnetic block, bottom magnetic boot and the inner wall of the housing. The materials of the housing, magnetic block, magnetic boot are well known in this market. For example, the housing is made of 1020(AISI/SAE); magnetic boot is made of 1010(AISI/SAE); and magnetic block is made of neodymium iron boron. The magnetic block 128 is a permanent magnet. The magnetic block 128, top and bottom magnetic boots 126 and 130, and the housing 127 form a stable magnetic field inside the housing. The arrows indicate the magnetic flux directions. Relating to the moving space of sensing coil and driving coil, and also for the magnetic flux direction and intensity of magnetic field, this magnetic field is divided into six (6) areas, as shown as 153A, 153B, 154A, 154B, 155A, 155B. 153A and 153B have the same intensity value of magnetic field, with opposite direction. Similarly, 154A and 155A can be considered to have the same intensity value of magnetic field as 154B and 155B respectively, with different direction. Area of 153A and 153B are the space between the shoulder face 213 of top magnetic boot (222 of bottom magnetic boot) and the inner wall of housing 127. Both 153A and 153B have the most well distributed (uniformed) magnetic field in the mentioned space.

FIG. 3 shows the assembling structure of magnetic boot and magnetic block. Both top magnetic boot 126 and bottom magnetic boot 130 are symmetric with its symmetric plane 144. The symmetric plane 144 is the geometric symmetric plane of the magnetic block 128 and perpendicular with its axis. The recess 215 of top magnetic 126 is for assembling cap 117 and recess 220 of bottom magnetic 130 is for assembling base 131.

The magnetic field 153A corresponds to cylindrical surface 213 (shoulder face of magnetic boot) of magnetic boot 126. Similarly, magnetic field 154A mainly corresponds to plane 214 of magnetic boot 126; magnetic 155A corresponds plane 210, cylindrical surface 211 and plane 212 of magnetic boot 126. By using the same method, 153B, 154B and 155B can be determined. Also, FIG. 2 shows that magnetic field 154A and 154B have the most well distributed intensity value of magnetic field with opposite direction. Therefore, if the sensing coil is fully located in these well-distributed magnetic field 154A and 154B, its output signal will have the least distortion corresponding to its original vibration. To reduce cost and the mechanical size, the coil 122A and coil 122B of driving coil set 122 are located in the magnetic field 154A and 154B, resulted in less uniform distributed magnetic field.

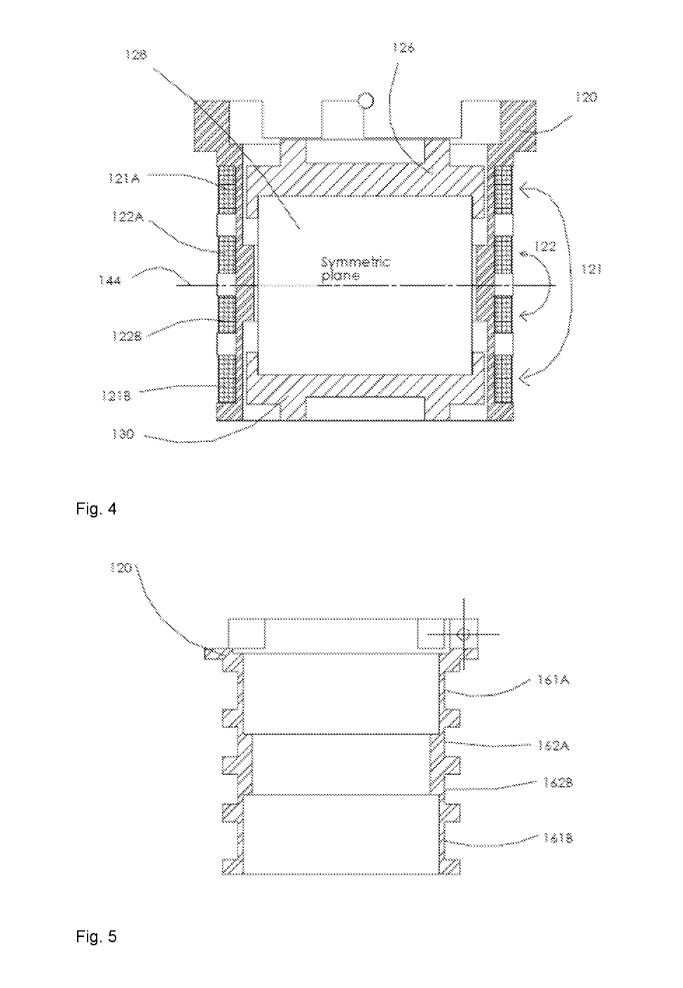

FIG. 4 shows the structure of bobbin, two coil sets, magnetic block and two magnetic boots. Symmetric plane 144 is located in the middle between the top plane and bottom plane of magnetic block 128 and is vertical with the cylindrical axis of magnetic block 128. Top magnetic boot 126 and bottom magnetic boot 130 are symmetrically assembled in the magnetic block with the symmetric plane 144. The four (4) recesses of the bobbin 120 are geometric symmetry to the symmetric plane 144. Top coil portion 121A and bottom coil portion 121B from sensing coil set 121 are symmetrically wound to the symmetric plane 144. Similarly, top coil portion 122A and bottom coil 122B portion from driving coil set 122 are also symmetrically wound to the symmetric plane.

For having the sensing coil sets totally located in the well uniformed magnetic field, the length of coil portion 121A is matching the length of top magnetic boot shoulder face 213 along cylindrical axis of magnetic block. For example, the length of coil portion 121A is equal to or smaller than the length of the length of magnetic boot shoulder face 213. Also, the working distance of the sensing coil is within 0.0002 mm while the conventional geophone is within +/−2 mm. By using the same method, the length of coil 121B is made equal to or smaller than the length of bottom magnetic boot shoulder face 222 and will be symmetric to 121A under the symmetric plane 144.

FIG. 5 shows the structure of the bobbin 120 which has 4 recesses. The recess 161A is for sensing coil portion 121A and 161B is for sensing coil portion 121B. Similarly, 162A is for driving coil 122A and 162B is for driving coil portion 122B. The movable coil structure comprises two sets of coils 121 and 122 being radically wound on the bobbin 120. The coil portion 121A and coil portion 121B of sensing coil set 121 are wound into recess 161A and recess 161B respectively. The coil portion 122A and coil portion 122B of driving coil set 122 are wound into recess 162A and recess 162B respectively.

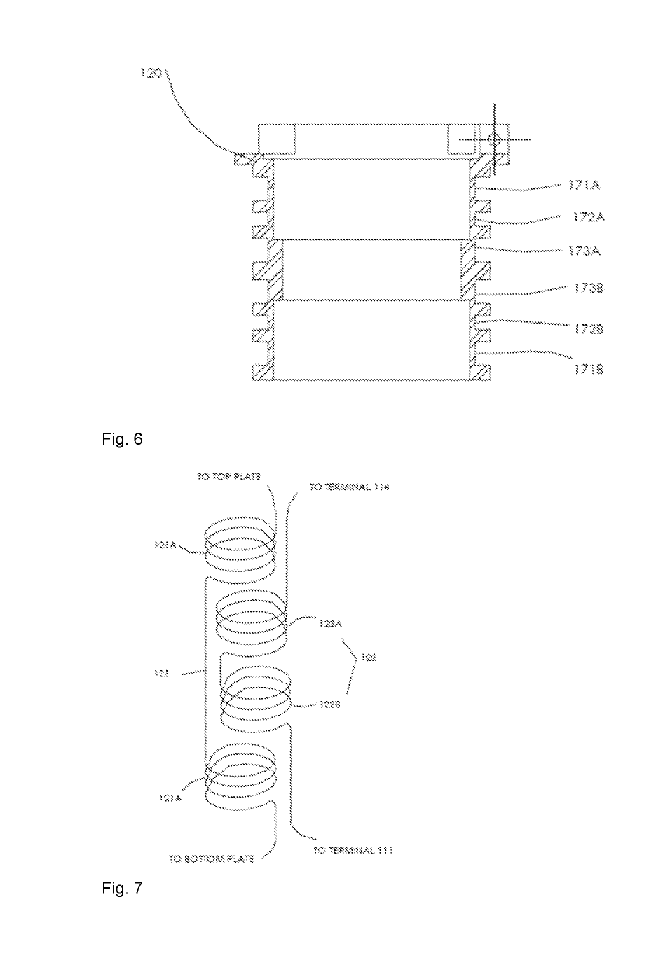

FIG. 6 shows a bobbin with six (6) recesses. Recesses 171A and 171B are for portion 183A and 183B of a coil set respectively. Similarly, 172A and 172B are for portion 182A and 182B of second coil set. 173A and 173B are for 181A and 181B of the third coil set. The bobbin can also be made to have more than six (6) recesses in which each recess will be wound by one or two coil portions by using the well-known technologies in this industry. For example, the bobbin has eight (8) recesses; or ten (10) recesses in some cases.

FIG. 7 shows a simplified three-dimensional illustration of two coil sets 121 and 122. The portion 121A and 121B of the first coil set can be wound to recesses 161A and 161B of the bobbin by the well-known technologies in this area. The coil portions 161A and 161B have the same wire length with opposite winding direction. Similarly, 122A is wound to 162A and 122B is wound to 162B in the opposition direction.

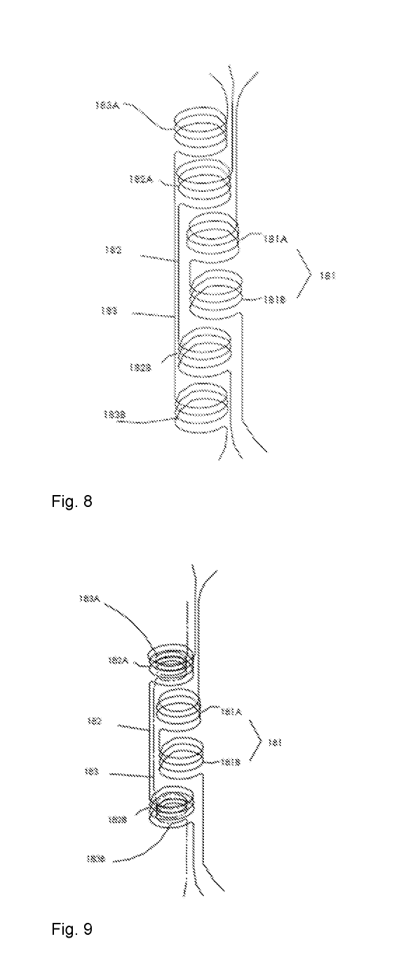

FIG. 8 shows a simplified three-dimensional illustration of three (3) coils sets, 181, 182 and 183. By using well-known technologies in this industry detailed above, the three (3) coil sets are wound to six (6) recesses separated as shown in FIG. 6. Other configurations of coil sets are also available. For example, more than three (3) coil sets can be wound to six (6) or more recesses separately, or some of the coil sets are overlapped while one or more than one of the coil sets are separately wound into the recesses.

FIG. 9 shows a simplified three-dimensional illustration of the combined windings of the three (3) coil sets. By using well known technologies in this industry, coil 183 is wound to the two recesses of the bobbin. Then, coil 182 is wound overlapped the two recesses of the bobbin by same technologies. Similarly, coil 181 is wound to another two recesses of the bobbin.

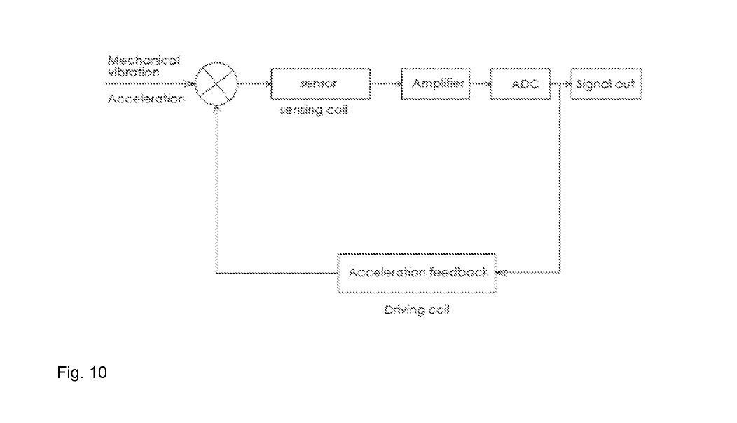

FIG. 10 is a block diagram illustrating a close-loop feedback geophone system. An external mechanical vibration or injected acceleration is detected by the sensing coil set. The electronic signal is amplified and then converted to digital by analog-to-digital converter (ADC). The driving coil set converts the electrical control signal to a feedback mechanical force and then injects it to the sensing coil set.

What is claimed is:

1. An apparatus for detecting vibration, said apparatus comprising:
1a) a housing and a magnetic structure forming a magnetic field in the housing; and
1b) a coil bobbin having at least 4 recesses and
1c) at least 2 sets of coils wound separately (or combined) in these recesses of coil bobbin, which is in space concentric with the magnetic structure and is movable with magnetic field; at least one set of coils being sensing coil, which is located in the well distributed magnet field magnitude area, to measure the mechanical vibration and at least one set of coils being driving coil to feedback control the bobbin for having a better performance geophone; and
1d) be located in separated recesses of bobbin, each coil portion of these coil sets having an individual magnet field magnitude by using faraday's law and Lorentz's law and
1e) the length of sensing coil portion is matching the length of pole piece;

2. The apparatus of claim 1 wherein at least two sets of coils are connected for outputting a sensing signal indicative of vibration.

3. The apparatus of any one of claims 1 to 2 wherein at least two sets of said two or more sets of coils are wound in the same direction.

4. The apparatus of any one of claims 1 to 2 wherein at least two sets of said two or more sets of coils are wound in opposite directions.

5. The apparatus of claim 1 wherein there are at least 4 terminals, which at least two terminals are connected to control device, while at least two terminals are for output vibration signal.
